(19) United States
(12) Patent Application Publication
(10) Pub. No.: US 2004/0206227 A1
(43) Pub. Date: Oct. 21, 2004

(54) Method of playing a game according to events in a selected track of a music file

(76) Inventor: Wen-Ni Cheng, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,494

(22) Filed: Apr. 15, 2003

(51) Int. Cl. G10H 1/18; G10H 7/00; H04Q 1/00

(52) U.S. Cl. 84/615

(57) ABSTRACT

A method for playing a game based on events in a music file. The method includes providing a first user interface to enable a user to select a music file to be played in the game, the selected music file comprising a plurality of tracks to be played simultaneously when the selected music file is played; providing a second user interface to enable the user to select a track from the plurality of tracks in the selected music file; calculating event times associated with note events in the selected track, each note event corresponding to a note in the selected track; playing the selected music file; and determining if an appropriate key is pressed within a predetermined period of time before or after each note event of the selected track.

### BACKGROUND OF INVENTION

1. Field of the Invention

The present invention relates to music files with multiple tracks, and more specifically, to a method for playing a game according to events in a selected track of a music file.

2. Description of the Prior Art

With the popularity of video games, many different types of games have developed. Currently, one popular game is a dancing game in which users press input pads in sync with a musical event in the game. The input pad can either be an input mat that is to be stepped on, or a normal input controller that is to be controlled by hand. Besides dancing games, other types of musical games can also be played using the same concept of pressing an input key in response to an event in the game's music.

Please refer to FIG. 1. FIG. 1 is a timing diagram of a prior art game 10 played according to events 20 in a song. Commonly, four directional arrows 12, 14, 16, and 18 are displayed on a screen, and each of the directional arrows 12, 14, 16, and 18 on the screen corresponds to an input key on the user's input pad. In the example illustrated in FIG. 1, seven events 20 are shown. The vertical axis of the diagram represents time, and each of the events begins at a bottom of the screen and progressively moves higher. When the events reach the directional arrows 12, 14, 16, and 18 at the top of the screen, the user should press the corresponding input key to score points. Each of the events 20 are generated according to events in the song that is being played as music in the game, with each song having its own set of events. Typically, the events correspond to notes produced by a rhythm instrument such as a drum or an instrument used for the main melody such as a guitar or piano. Since each song may have many instruments, Musical Instrument Digital Interface (MIDI) files can be used for providing songs in the game.

Please refer to FIG. 2. FIG. 2 is a diagram showing a basic structure of a MIDI file 30 according to the prior art. The MIDI file 30 is composed of a series of bytes of data, each represented in hexadecimal format in FIG. 2. The MIDI file 30 shown in FIG. 2 contains a file header 32, a first track 36, a second track 38, and a third track 40. The file header 32 includes a track number indicator 34 for indicating a total number of tracks included in the MIDI file 30. In this case, the track number indicator 34 contains a value of “3” since there are three tracks. Each of the tracks 36, 38, and 40 can be used for storing the notes of a different instrument, so the MIDI file 30 shown in FIG. 2 may contain music for three different instruments.

Unfortunately, in the prior art video games played based on events in the music, the users are not allowed to choose a track corresponding to the instrument they would like to use for providing the music events used in the game. Instead of being able to play the game in response to notes of a piano, for instance, the game will always use the events of the same instrument, such as a drum. Moreover, each video game only comes with a limited selection of songs, and new songs cannot be added. Therefore, after playing the video game several times, the user may become bored due to the lack of variety in the game.

### SUMMARY OF INVENTION

It is therefore a primary objective of the claimed invention to provide a method for playing a game based on events in a music file in order to solve the above-mentioned problems.

According to the claimed invention, a method for playing a game based on events in a music file is disclosed. The method includes providing a first user interface to enable a user to select a music file to be played in the game, the selected music file comprising a plurality of tracks to be played simultaneously when the selected music file is played; providing a second user interface to enable the user to select a track from the plurality of tracks in the selected music file; calculating event times associated with note events in the selected track, each note event corresponding to a note in the selected track; playing the selected music file; and determining if an appropriate key is pressed within a predetermined period of time before or after each note event of the selected track.

It is an advantage of the claimed invention that different tracks within the music file can be selected for providing events used in the game. This provides more choices for the user, and makes the game more enjoyable.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a timing diagram of a prior art game played according to events in a song.

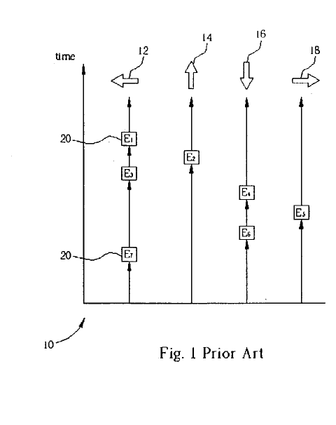

FIG. 2 is a diagram showing a basic structure of a MIDI file according to the prior art.

FIG. 3 is a detailed diagram of a second track of the MIDI file shown in FIG. 2.

FIG. 4 is a chart showing timing of each event in the second track.

FIG. 5 is a chart showing absolute times of all note-on events shown in FIG. 4.

FIG. 6 is a flowchart illustrating game play according to the present invention method.

FIG. 7 is a flowchart further illustrating calculating the note-on events for the selected track (step 100 in the flowchart of FIG. 6) according to the present invention method.

### DETAILED DESCRIPTION

The present invention provides more flexibility to the user by allowing new songs to be added to a list of songs available for the game and by allowing individual tracks of a music file to be selected for providing music events used in the game.

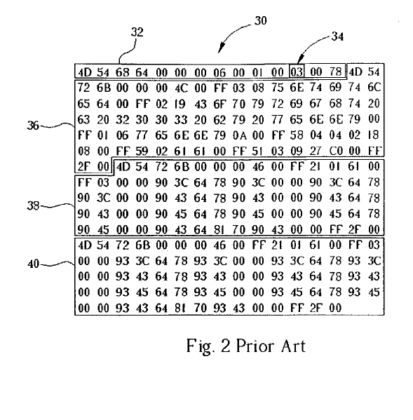

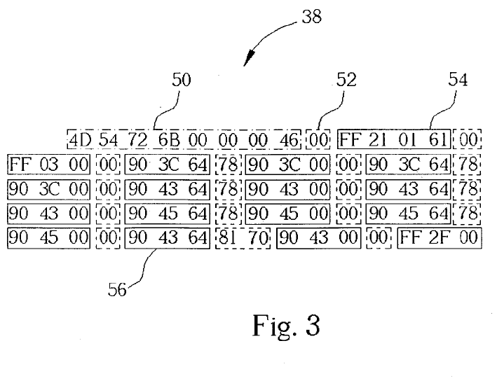

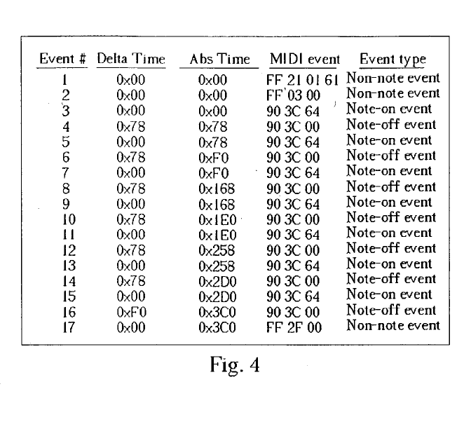

Please refer back to FIG. 2. The MIDI file 30 shown in FIG. 2 contains the first track 36, the second track 38, and the third track 40. For showing how individual tracks can be selected from the MIDI file 30, the second track 38 will be used as an example. Please refer to FIG. 3 and FIG. 4. FIG. 3 is a detailed diagram of the second track 38 of the MIDI file 30 shown in FIG. 2. FIG. 4 is a chart showing timing of each event in the second track 38. Suppose that the user wishes to use the notes of the instrument represented in second track 38 for providing music events used in the video game. The present invention first involves analyzing the selected track for note-on events, which are events in the song representing the start of a note. The second track 38 contains a track header 50, a plurality of delta times 52, a plurality of non-note events 54, and a plurality of note-events 56. The delta time 52 is placed before each non-note event 54 and note-event 56 for indicating a period of elapsed time before that event. Since the non-note events 54 do not play any notes in the second track 38, the delta time 52 before each non-note event 54 is equal to “00”. The delta time 52 is varied to change the duration of notes that are specified in the note-events 56.

All of the non-note events 54 and note-events 56 are shown in rows of FIG. 4. Five columns in FIG. 4 show an event number given for reference, the delta time 52 value, an absolute time of the event, the byte representation of the event, and the event type. The delta time 52 value shows the amount of time that elapses between the previous event and the current event. The absolute time values show an absolute time of an event, which is calculated by adding up all of the previous delta time 52 values. Three different event types are shown in FIG. 4. The non-note events 54 do not affect audible notes, the note-on events are the starts of new notes, and the note-off events are the endings of notes.

To further illustrate the events shown in FIG. 4, the first six events will be briefly described. The first two events are non-note events, each having a delta time of “0×00” (hexadecimal) preceding it.

The third event is a note-on event having a delta time of “0×00” preceding it. Therefore, the absolute time at which the third event begins is still at “0×00”. The byte representation for this event is “90 3C 64”, wherein the “3C” byte represents a pitch of the note being played and the “64” byte represents a volume of the note.

The fourth event is a note-off event having a delta time of “0×78” preceding it. Therefore, the absolute time at which the fourth event begins is at “0×78”. The byte representation for this event is “90 3C 00”, representing that the volume of the previous note has now been set to “00”, which is zero volume. Since the absolute time at which the note began was at “0×00” and the absolute time at which the note ended was at “0×78”, the duration of the note was “0×78”.

The fifth event is a note-on event having a delta time of “0×00” preceding it. Therefore, the absolute time at which the fifth event begins is still at “0×78”. In fact, the fifth event begins playing the same note as the previous note immediately after the previous note has stopped playing.

The sixth event is a note-off event having a delta time of “0×78” preceding it. Therefore, the absolute time at which the sixth event begins is at “0×F0”, which is “0×78”+“0×78”. The sixth event terminates the event that was begun in the fifth event. Therefore, a total of two notes have been played, with each note having the same pitch and same duration. This is analogous to playing two quarter notes of the same pitch one right after the other.

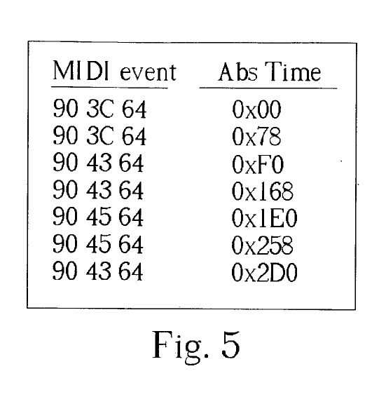

When playing a video game based on music events, only note-on events are used for the user to press a corresponding input key. Please refer to FIG. 5. FIG. 5 is a chart of an event buffer showing absolute times of all the note-on events shown in FIG. 4. After the user selects a track in the music file, the selected track will be searched for finding the note-on events and their corresponding absolute times. These will then be stored in an event buffer for use in the game. As the game is played, the note-on events will be taken out of the event buffer in sequential order and the user will attempt to press corresponding input keys at about the same absolute time as the occurrence of the note-on events.

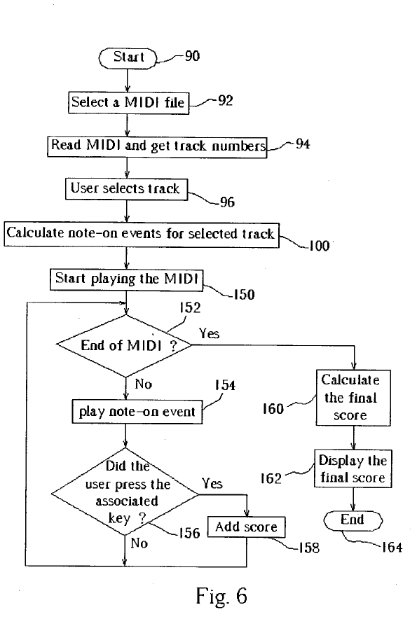

Please refer to FIG. 6. FIG. 6 is a flowchart illustrating game play according to the present invention method. Steps contained in the flowchart will be explained below.

Step 90: Start;

Step 92: Select a MIDI file containing a song to be played in the game. The user is capable of adding or deleting MIDI files from a list of available songs. The MIDI files can be downloaded or created by the user for adding the files to the list;

Step 94: The selected MIDI file is read, and the total number of track numbers is read;

Step 96: From the available tracks, the user selects a track to be used for providing the note-on events used in the game;

Step 100: Calculate the note-on events for the selected track;

Step 150: Start playing the game with the selected MIDI file used as the music for the game;

Step 152: Determine if the end of the MIDI file has been reached; if so, go to step 160; if not, go to step 154;

Step 154: Play the next note-on event in the event buffer;

Step 156: Determine if the user pressed an associated input key within a predetermined period of time before or after the note-on event; if so, go to step 158; if not, go back to step 152;

Step 158: Add points to the score of the user for correctly pressing the input key in response to the note-on event; go to step 152;

Step 160: Calculate the final score of the game;

Step 162: Display the final score; and

Step 164: End.

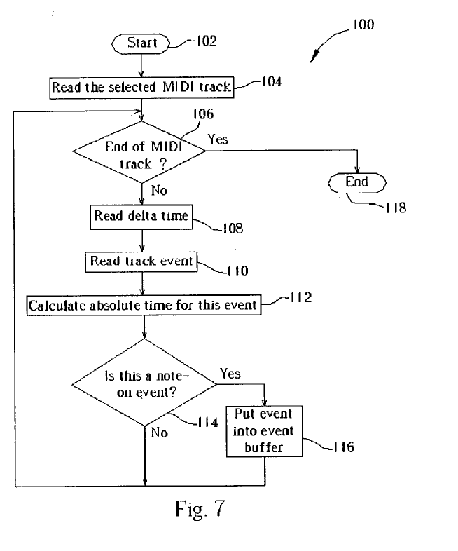

Please refer to FIG. 7. FIG. 7 is a flowchart further illustrating calculating the note-on events for the selected track (step 100 in the flowchart of FIG. 6) according to the present invention method. Steps contained in the flowchart will be explained below.

Step 102: Start;

Step 104: Read the selected MIDI track;

Step 106: Determine if the end of the MIDI track has been reached; if so, go to step 118; if not, go to step 108;

Step 108: Read next delta time;

Step 110: Read next track event;

Step 112: Calculate the absolute time for this event by adding up all previous delta times;

Step 114: Determine if this event is a note-on event; if so, go to step 116; if not, go to step 106;

Step 116: Put this note-on event into the event buffer; go to step 106; and

Step 118: End.

Compared to the prior art, the present invention method allows users to select a track within a music file that corresponds to the instrument they would like to use for providing the music events used in the game. Moreover, new songs can be added to the list of songs available for the game by downloading songs or creating new songs. With these advantages, the present invention method allows game playing to be more flexible and more enjoyable for users.

Those skilled in the art will readily observe that numerous modifications and alterations of the device may be made while retaining the teachings of the invention. Accordingly, the above disclosure should be construed as limited only by the metes and bounds of the appended claims.

1. A method for playing a game based on events in a music file, the method comprising:
providing a first user interface to enable a user to select a music file to be played in the game, the selected music file comprising a plurality of tracks to be played simultaneously when the selected music file is played, all sounds played by the music file being produced by the plurality of tracks in the music file among which the user may select, and the plurality of tracks containing notes that correspond to different musical instruments;
providing a second user interface to enable the user to select a track from the plurality of tracks in the selected music file;
calculating event times associated with note events in the selected track, each note event corresponding to a note in the selected track;
playing the selected music file; and
determining if an appropriate key is pressed within a predetermined period of time before or after each note event of the selected track.

2. The method of claim 1 wherein each note event is a note-on event that indicates a start of the corresponding note.

3. The method of claim 1 wherein the event time associated with each not event is calculated as an absolute time.

4. The method of claim 3 wherein each event in the selected track has an associated delta time, and the absolute time for each note event is calculated by adding all delta times associated with preceding events.

5 (original): The method of claim 1 wherein each note event and the event time associated with the note event is stored in an event buffer.

6. The method of claim 1 wherein a score is earned when the appropriate key is pressed within the predetermined period of time before or after each note event of the selected track.

7. The method of claim 6 wherein a total score for the game is calculated when the selected music file stops playing.

8. The method of claim 1 wherein selecting a music file to be played in the game comprises enabling the user to choose the selected music file from a list of available music files.

9. The method of claim 8 wherein music files may be added to or deleted from the list of available music files.

10. The method of claim 8 wherein downloaded music files may be added to the list of available music files.

11. The method of claim 1 wherein the selected music file is a Musical Instrument Digital Interface (MIDI) file.

12. An electronic gaming device for implementing the method of claim 1.
